(19) United States
(12) Patent Application Publication
(10) Pub. No.: US 2014/0215898 A1
(43) Pub. Date: Aug. 7, 2014

(54) ANTI-ANT DEVICE

(71) Applicant: CHIEN-KO HSU, TAINAN CITY (TW)

(72) Inventor: CHIEN-KO HSU, TAINAN CITY (TW)

(21) Appl. No.: 13/756,805

(22) Filed: Feb. 1, 2013

(51) Int. Cl. A01M 29/34

(52) U.S. Cl. CPC A01M 29/34
USPC 43/121

(57) ABSTRACT

An anti-ant device includes an object having a recess defined in the underside thereof and a support extends from the underside of the object and located at the center of the recess. An anti-ant member is located in the recess and mounted to outside of the support. When ants climb along the support, the anti-ant member generates substance to keep the ants away from it, so as to avoid the ants from reaching food on the object.

### BACKGROUND OF THE INVENTION

1. Fields of the Invention

The present invention relates to an anti-ant device, and more particularly, to an anti-ant device for preventing ants from reaching food on an object such as a table.

2. Descriptions of Related Art

Food on an object such as a table can easily attract ants within a short period of time. Even if the food is discarded into a garbage can, ants can quickly gather by the food in the garbage can by climbing along the wall of the garbage can. These ants may bring germs to the food and contaminate the environment, they usually access other foods in the room to cause other damage.

The present invention intends to provide an anti-ant device which is effective and easily installed.

### SUMMARY OF THE INVENTION

The present invention relates to an anti-ant device and comprises an object having a recess defined in the underside thereof and a support extends from the underside of the object and located at the center of the recess. An anti-ant member is located in the recess and mounted to outside of the support. A first ring is engaged with the inside of the recess and a second ring is mounted to the support. Two respective tops of the first and second rings contact the underside of the anti-ant member. When ants climb along the support, the anti-ant member generates substance which the ants do not like so as to avoid the ants from reaching food on the object.

The anti-ant device is located at the underside of the object so that kids or pets cannot touch the anti-ant members. Besides, the anti-ant members are made by non-poisonous material so that even if kids or pets touch them, no health risk is incurred.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the anti-ant device of the present invention;

FIG. 2 is a cross sectional view of the anti-ant device of the present invention;

FIG. 3 is a cross sectional view to show the use of the anti-ant device of the present invention;

FIG. 4 is a perspective view to show the second embodiment of the anti-ant device of the present invention;

FIG. 5 is a perspective view to show the use of the second embodiment of the anti-ant device of the present invention;

FIG. 6 is a cross sectional view showing the third embodiment of the anti-ant device of the present invention, and

FIG. 7 is a cross sectional view to show the fourth embodiment of the anti-ant device of the present invention.

### DETAILED DESCRIPTION OF THE PREFERRED EMBODIMENT

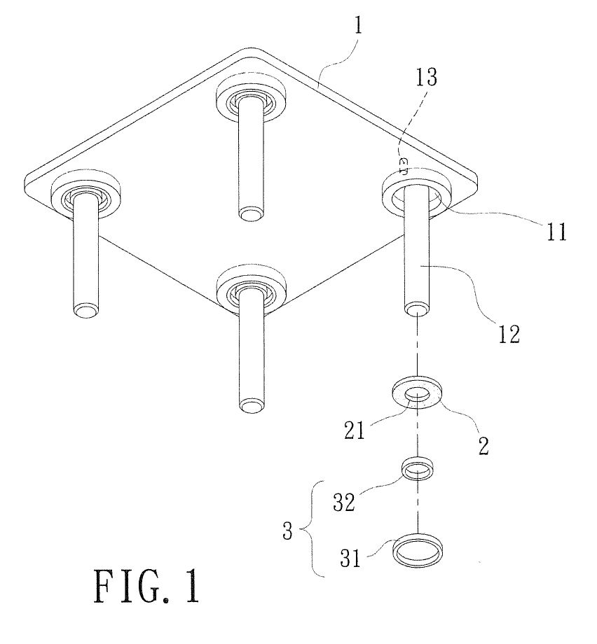

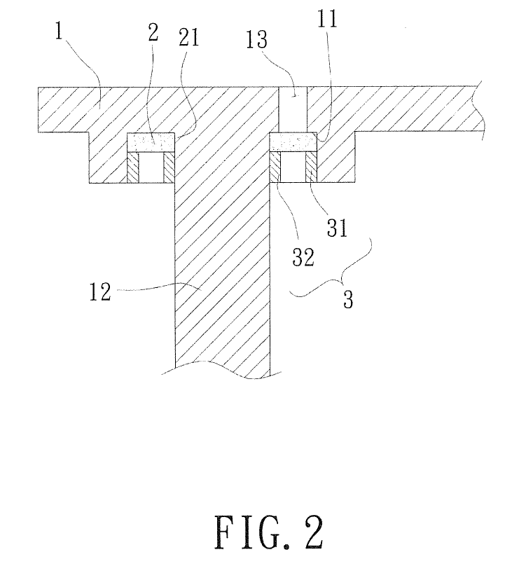

Referring to FIGS. 1 and 2, the anti-ant device of the present invention comprises an object 1, an anti-ant member 2 and a ring unit 3.

The object 1 has a recess 11 defined in the underside thereof. A support 12 extends from the underside of the object 1 and located at the center of the recess 11. A through hole 13 is defined through the top of the object 1 and communicates with the recess 11.

The anti-ant member 2 is a ring-shaped member and has a mounting hole 21 defined through the center of the anti-ant member 2. The anti-ant member 2 is mounted to the support 12 and located in the recess 11, so that the inner periphery of the mounting hole 21 is in contact with the outside of the support 12. The anti-ant member 2 comprises 60% pepper, 20% mint, 10% garlic and 10% vinegar.

The ring unit 3 comprises a first ring 31 and a second ring 32. The first ring 31 is engaged with the inside of the recess 11 and the second ring 32 is mounted to the support 12. The two respective tops of the first and second rings 31, 32 contact the underside of the anti-ant member 2.

In practical use, the object 1 can be a table and the recesses 11 are defined in the underside of the table. The four legs of the table are the four supports 12. Four anti-ant members 2 each are located in the recess 11 corresponding thereto. The first ring 31 is engaged with the inside of each of the recesses 11 and the four second rings 32 are respectively mounted to the four supports 12. In each recess 11, the two respective tops of the first and second rings 31, 32 contact the underside of the anti-ant member 2 so as to position the anti-ant member 2.

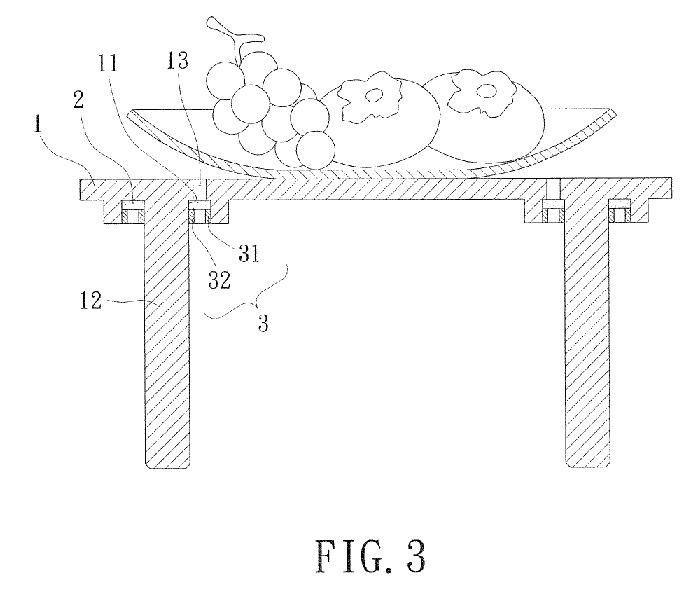

As shown in FIG. 3, food is put on the object 1 which is the table, and ants climb along the supports 12, when the ants climb to the underside of the table, they encounter the anti-ant members 2 around the supports 12. The substance that is generated by the anti-ant members 2 can prevent the ants from continuously climbing to the top of the object 1 so that the food on the object 1 can be protected from the ants. When the functions of the anti-ant members 2 gradually weakened along with time and contact with air, the uses may inject the liquid containing the proper contents into the anti-ant members 2 via the through holes 13.

The anti-ant device is located at the underside of the object 1 so that kids or pets cannot touch the anti-ant members 2. Besides, the anti-ant members 2 are made by non-poisonous material so that even if kids or pets touch them, no health risk is incurred. Furthermore, the anti-ant members 2 are located at the underside of the object 1 so that dusts are not easily attached with the anti-ant members 2 to prolong the life time of the anti-ant members 2. This also reduces the economical burden of the users. Besides, the ring unit 3 can be O-ring, C-shaped clip or E-shaped clip which is easily purchased in the market with less cost.

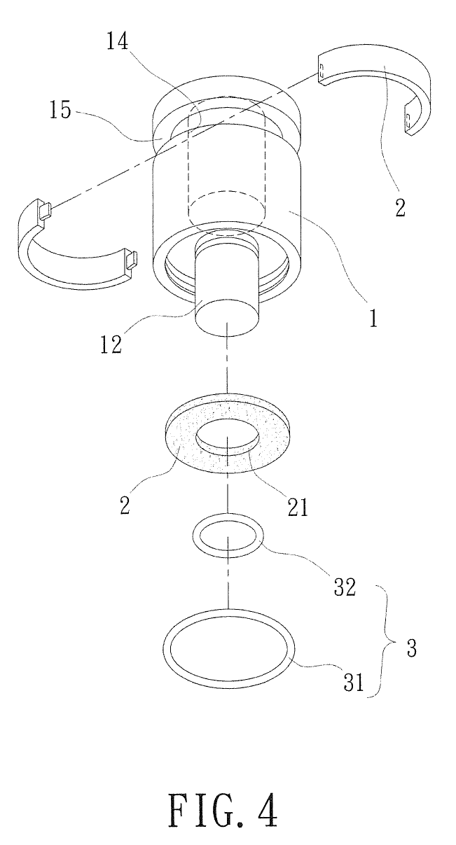

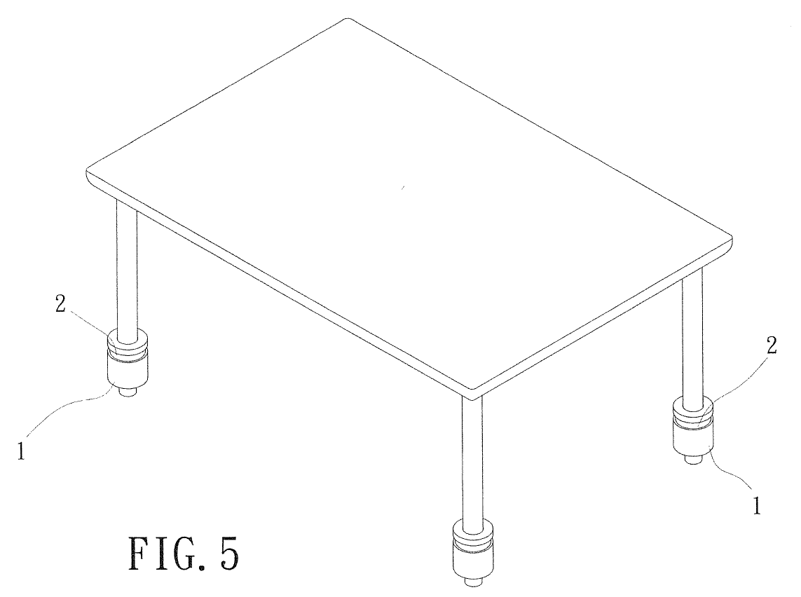

FIGS. 4 and 5 show that the object 1 is a cylindrical object and an insertion hole 14 is defined in the top of the object 1. A groove 15 is defined in the outside of the object 1 and another anti-ant member 2 is engaged with the groove 15. When in use, the leg of a table is inserted into the insertion hole 14 of the object 1 and the four legs of the table are cooperated with four anti-ant devices. The supports 12 of the four anti-ant devices contact the floor. When the ants climb along the supports 12, the anti-ant member 2 in the recess of each anti-ant device stops the ants as mentioned above. If the anti-ant members 12 in the recesses 11 loose proper function, and the ants climb to the outside of each of the objects 1, the second anti-ant members 2 in the grooves 15 can stop the ants. Therefore, the food on the table is protected.

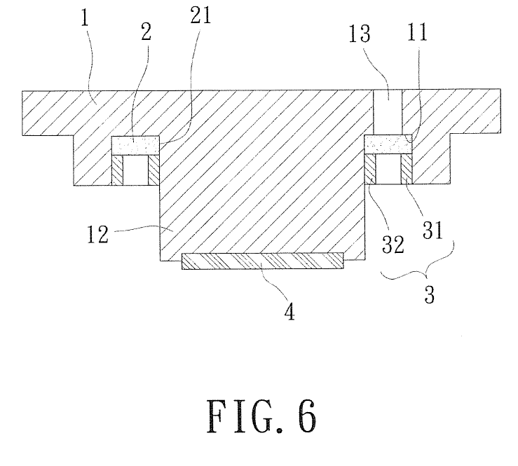

FIG. 6 shows that an anti-slip pad 4 is connected to the underside of the support 12. The anti-slip pad 4 ensures that the object 1 is firmly put on the floor and does not slip or fall. Therefore, the anti-ant devices of the present invention can be installed and functioned when installed to the object 1.

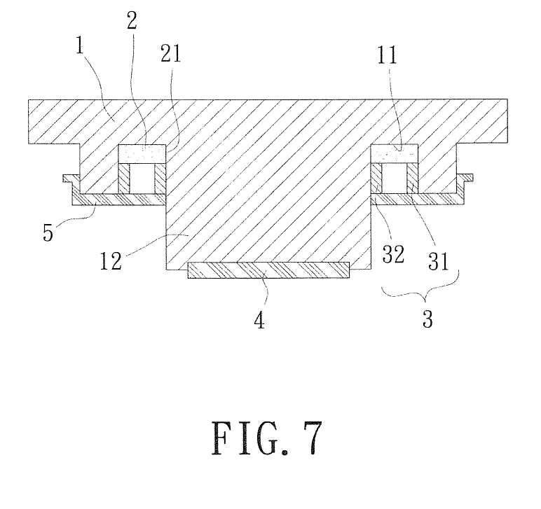

FIG. 7 further shows that a cover 5 is mounted to the wall of the recess 11 of the object 1 so as to seal the recess 11. When the object 1 is to be cleaned by water, the anti-ant member 2 in the recess 11 can be protected from being in contact with the water.

The object 1 can be chair, table or any object. The legs of the chair or table are the supports 12. The garbage can is put on the chair or the table to keep ants away from the garbage can. The legs of the chair or the table can also be inserted into the insertion holes 14 of the anti-ant devices as mentioned in FIG. 4 to achieve the same function.

While we have shown and described the embodiment in accordance with the present invention, it should be clear to those skilled in the art that further embodiments may be made without departing from the scope of the present invention.

What is claimed is:

1. An anti-ant device comprising:
an object having a recess defined in an underside thereof, a support extending from the underside of the object and located at a center of the recess;
an anti-ant member located in the recess and mounted to outside of the support, and
a first ring engaged with an inside of the recess, a second ring mounted to the support, two respective tops of the first and second rings contacting an underside of the anti-ant member.

2. The anti-ant device as claimed in claim 1, wherein a through hole is defined through a top of the object and communicates with the recess.

3. The anti-ant device as claimed in claim 2, wherein an insertion hole is defined in a top of the object.

4. The anti-ant device as claimed in claim 3, wherein a groove is defined in an outside of the object and another anti-ant member is engaged with the groove.

5. The anti-ant device as claimed in claim 2, wherein an anti-slip pad is connected to an underside of the support.

6. The anti-ant device as claimed in claim 1, wherein an insertion hole is defined in a top of the object.

7. The anti-ant device as claimed in claim 1, wherein a groove is defined in an outside of the object and another anti-ant member is engaged with the groove.

8. The anti-ant device as claimed in claim 1, wherein an anti-slip pad is connected to an underside of the support.

9. The anti-ant device as claimed in claim 1, wherein a cover is mounted to a wall of the recess of the object.

10. The anti-ant device as claimed in claim 1, wherein the anti-ant member comprises 60% pepper, 20% mint, 10% garlic and 10% vinegar.
